(19) United States
(12) Patent Application Publication
(10) Pub. No.: US 2010/0232380 A1
(43) Pub. Date: Sep. 16, 2010

(54) SYSTEM AND METHOD FOR UTILIZING SPECTRUM OPERATION MODES IN DYNAMIC SPECTRUM ACCESS SYSTEMS

(75) Inventors: Young-June Choi, Suwon (KR); Dragos Niculescu, Bucuresti (RO); Ashwini Kumar, Ann Arbor, MI (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/720,031

(22) Filed: Mar. 9, 2010

Related U.S. Application Data
(60) Provisional application No. 61/158,919, filed on Mar. 10, 2009.

(51) Int. Cl. H04W 4/00

(52) U.S. Cl. 370/329

(57) ABSTRACT

A system and method for enabling primary and secondary user coexistence for a wireless system includes performing spectrum sensing in a channel to determine primary user usage in a first mode of operation. It is determined whether the primary user usage includes a pattern of usage. If a pattern of usage is detected, a second mode of operation is engaged which includes at least reducing spectrum sensing by a secondary user to permit secondary user usage of the channel.

### RELATED APPLICATION INFORMATION

This application claims priority to provisional application Ser. No. 61/158,919 filed on Mar. 10, 2009, incorporated herein by reference.

### BACKGROUND

1. Technical Field

The present invention relates to allocation of bandwidth of dynamic spectrum access systems and more particularly to systems and methods for operating dynamic spectrum access systems which protect primary users and more efficiently provide access to secondary users.

2. Description of the Related Art

Scarce radio spectrum can be utilized more efficiently via Dynamic Spectrum Access (DSA) that is enabled by cognitive radio (or software-defined radio) technology. DSA refers to a medium access strategy through which secondary users (SUs) can opportunistically communicate on a channel that is licensed to different primary users (PUs). This secondary access takes place during spectrum white spaces—time intervals when the channel is free from transmissions by its authorized licensees (i.e., PUs). Therefore, spectrum should be managed for efficient coexistence between PUs and SUs.

The Federal Communications Commission (FCC) has recently approved commercial unlicensed operations in the UHF spectrum. With the growing importance of DSA among future wireless communication technologies, it is expected that new laptops with integrated DSA-enabled cards on top of legacy WiFi will soon appear in the market. These wireless devices will provide dramatically increased bandwidth to mobile end-users by using spectrum white spaces as well as conventional unlicensed bands (e.g., ISM bands).

### SUMMARY

The 802.11 medium access control (MAC) protocol can be adapted to a certain spectrum white space without interfering with PUs' transmission in accordance with the present invention. The augmented 802.11 MAC is referred to as the Spectrum-Conscious WiFi (SpeCWiFi). One requirement to implement SpeCWiFi is that PUs' transmission should be protected from SUs. We call this coexistence metric PU-safety. Licensees are extremely concerned about interference from SUs, and hence reluctant to support DSA operations in their channels.

In the United States, regulatory guidelines from the FCC govern the incumbent protection. For instance, SUs must not begin transmission when there is a PU signal on the channel. Also, any ongoing SU transmissions must be terminated within a very short time-interval, whenever PU transmission is detected. Detection of a PU signal is done through various spectrum-sensing techniques.

Based on the regulatory guidelines, absolute time-limit-based PU-safety parameters are followed in conventional DSA coexistence. According to the FCC's Dynamic Frequency Selection (DFS) model for the 5 GHz band, SUs must leave a channel within 2 seconds, whenever a PU returns to this channel. However, such a simple time constraint-based policy and its consequent coexistence design are appropriate only for channels where PUs are either ON or OFF for long durations as in TV bands.

A system and method for enabling primary and secondary user coexistence for a wireless system includes performing spectrum sensing in a channel to determine primary user usage in a first mode of operation. It is determined whether the primary user usage includes a pattern of usage. If a pattern of usage is detected, a second mode of operation is engaged which includes at least reduce spectrum sensing by a secondary user or completely eliminate it and permit secondary user usage of the channel.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a channel access diagram showing a sensing period for determining primary user usage;

FIG. 2 is a block/flow diagram for a system/method for enabling primary and secondary user coexistence for a wireless system in accordance with one illustrative embodiment;

FIG. 3 is a diagram showing a wireless system where primary and secondary user coexistence is maintained in accordance with one illustrative embodiment;

FIG. 4 is a diagram showing primary and secondary user usage of a licensed channel in accordance with one illustrative example;

FIG. 5 is a state-transition diagram showing different modes of operation in accordance with one illustrative embodiment; and

FIG. 6 is a channel access diagram showing a sensing period and other periods in a defer access period.

### DETAILED DESCRIPTION OF PREFERRED EMBODIMENTS

In accordance with the present principles, limited interference (ideally none) from secondary users (SUs) to primary users (PUs) is provided in to dynamic spectrum access (DSA) coexistence. DSA coexistence or simply coexistence herein refers to PU-SU coexistence, rather than SU-SU or any other form of self-coexistence. In designing spectrum conscious WiFi (SpeCWiFi), PUs are interfered with by SUs as little as possible, while at the same time, SUs utilize spectrum white spaces as much as possible. There is an inherent trade-off between PU-safety and SU-efficiency, because increase in channel utilization of SUs can lead to increase in interference to PUs. To precisely quantify this tradeoff, we define the Coexistence Goodness Factor (CGF) that incorporates the effect of both the parameters-utilization of SUs and interference to PUs, which are used in determining the quality of coexistence.

To enhance coexistence performance defined as a CGF-based multi-objective function, we provide an intelligent dual-mode medium access control (MAC) operation model such that SUs can access spectrum white spaces in a better and more efficient way. The default mode of operation in a licensed channel is the Safe Mode (SM). Licensed channel means licensed for PUs. In SM, SUs limit their own transmissions to minimize interference to PUs while trying to estimate a PU's channel-usage pattern, if any. Once a PU pattern is established, the MAC switches to Aggressive Mode (AM) where transmissions are scheduled to maximally utilize available spectrum white spaces. For example, in 802.16h systems, frames are sent periodically, so SUs may utilize the spectrum white spaces aggressively, rather than wasting the white spaces for sensing, if the pattern of frames is known. Further, given the short ON/OFF time-scales, accurate sensing, and the opportunistic use of the channel by a SU may be short-lived as the PU is expected to return to use the channel within short durations.

To detect and estimate PUs' usage patterns, we propose methods based on, e.g., Approximate Entropy (ApEn) to analyze the sensing information modeled as time-series data in an observation window. The ApEn-based approach is found particularly suitable for SpeCWiFi MAC, as it is reliable and introduces negligible overhead compared to other commonly-used pattern recognition techniques. We evaluate the developed SpeCWiFi MAC through both simulation and MadWiFi implementation. The evaluation results show the effectiveness of the coexistence mechanisms in improving performance with minimal overhead.

In accordance with the present embodiments, key challenges are identified for utilization of SUs and safety of PUs for coexistence and a CGF goal is provided. An ApEn-based method detects a pattern of PUs' spectrum usage, and develops a SpeCWiFi MAC that switches between SM and AM based on the method. A SpeCWiFi MAC is provided which improves coexistence performance, which is illustratively defined using a MadWiFi implementation.

In DSA wireless networks, secondary users (SUs) access a channel that is licensed to a different set of primary users (PUs). To coexist with PUs on that channel, SUs should not interfere with PUs, that is, they should not access that channel whenever PUs use it. To protect PUs' channel usage, SUs perform spectrum sensing on that channel. Spectrum sensing degrades SUs' channel utilization. To enhance the utilization of SUs, the SUs need to recognize ON and OFF periods of PUs and a usage pattern if the channel is used with a certain pattern. When there is a usage pattern of PUs, SUs need not incur spectrum sensing. The present embodiments improve channel utilization by using this pattern information to reduce or eliminate spectrum sensing by SUs. To protect PUs' transmission from SUs' access, SUs defer their access by a Quiet Period Interval (QPI). When PUs access the channel with a pattern, SUs may not defer the access, so QPI is minimized, once the pattern is found. The DSA mode is classified into two or more modes. For example, a regular mode and an aggressive mode may be employed. In the aggressive mode, SUs may skip the QPI. The solution enhances the utilization of SUs in DSA systems while protecting PUs' transmission.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable storage medium providing program code for use by or in connection with a computer or any instruction execution system. A computer-usable or computer readable storage medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

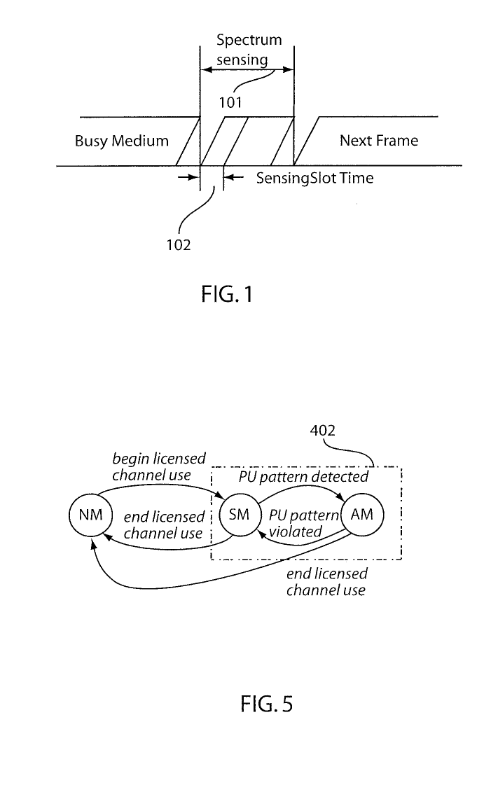

Referring now to the drawings in which like numerals represent the same or similar elements and initially to FIG. 1, an access method is illustratively depicted for a Dynamic Spectrum Access (DSA) system. Spectrum sensing is performed in time slot 101. Spectrum sensing is performed periodically or every time before transmission. A sensing time slot 102 is depicted for illustrative purposes. Normal DSA operations are conducted in other time slots (e.g., “Busy Medium” and “Next Frame”) surrounding the spectrum sensing time slot 101. FIG. 1 reflects a regular mode of operation.

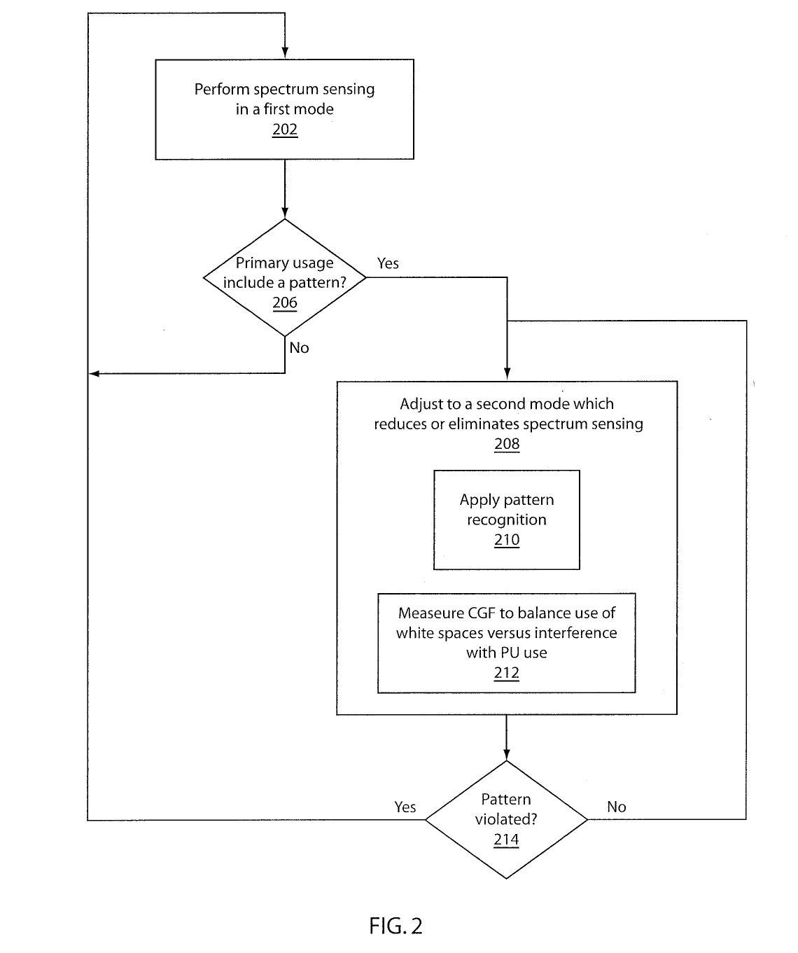

Referring to FIG. 2, a block/flow diagram showing a dual mode for DSA operation is illustratively depicted. DSA operations are executed in a network. During certain events, primary users (PUs) may not be using a particular channel or channels. The DSA operations are configured to protect PUs channel usage and achieve secondary users (SUs) high channel resolution. This may include permitting usage of the spectrum when PUs are not and during spectrum sensing intervals when a pattern of use for PUs has been detected. If SUs find a pattern of PUs' channel usage, the SUs enter an aggressive mode where spectrum sensing (101) may be skipped or the length of spectrum sensing is maintained below a permissible threshold such that SU use is permitted. A check is made for a PU usage pattern in a channel of the DSA system. If a pattern is found, then the spectrum sensing phase can be eliminated.

In block 202, spectrum sensing is performed in a channel to determine primary user usage in a first mode of operation. In block 206, a determination is made as to whether the primary user usage includes a pattern of usage. If a pattern of usage is detected, in block 208, an adjustment to a second mode (aggressive mode) of operation is provided which includes at least reducing or preferably eliminating spectrum sensing by a secondary user to permit secondary user usage of the channel. The pattern of usage includes applying a pattern recognition method to determine the pattern of usage in block 210. This may include computing a correlation sum to determine a similarity between vectors to compute an approximate entropy measure to determine whether the pattern exists. Other methods may be employed.

In block 212, reducing spectrum sensing includes measuring a coexistence goodness factor (CGF) to determine efficient usage of the channel. The coexistence goodness factor (CGF) balances utilization of channel white spaces and interference with primary user usage of the channel. The spectrum sensing is preferably performed by a secondary user. In block 214, if the pattern of usage is violated, readjustment is made back to the first mode of operation.

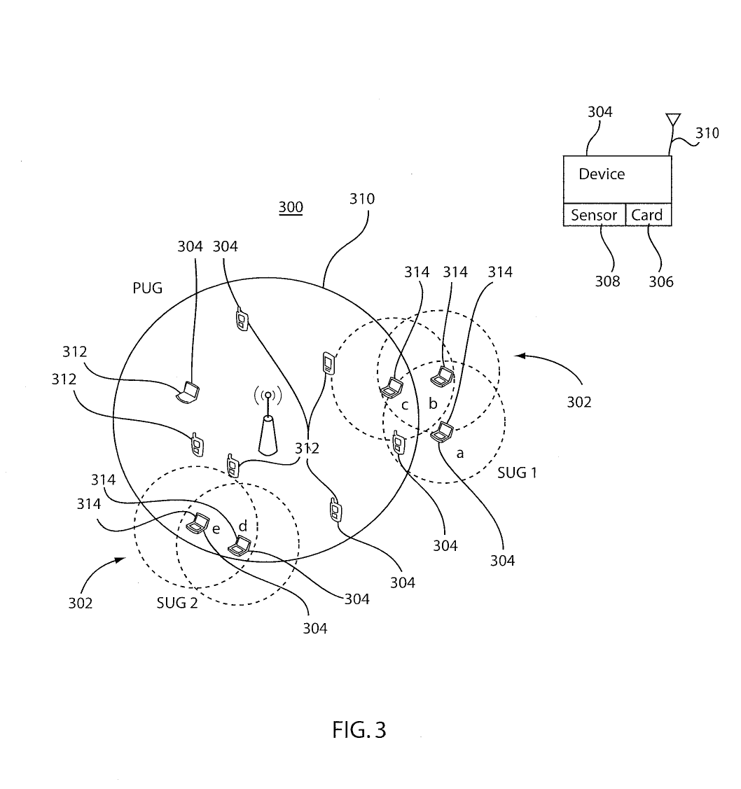

For a system model as depicted in FIG. 3, a network 300 of secondary user groups (SUGs) 302 (e.g., SUG 1 and SUG 2) is considered, each including multiple SUs based on SpeCWiFi. A SpeCWiFi-based SUG may operate in an unlicensed band allocated to WiFi systems. In one embodiment, a SpeCWiFi device 304 (e.g., a laptop or other portable device) is equipped with a DSA-enabled wireless card 306 (e.g., a transceiver card) as well as an additional spectrum sensor 308 and a wideband antenna 310, e.g., an omni-directional antenna. A SUG 302 can dynamically tune to another channel that is licensed to a specific primary user group's (PUG's) network 310. We focus on the operation of a SUG 302 in such a channel, not in a WiFi channel. There can be multiple PUGs 310 and SUGs 302 operating in close geographical vicinity and hence they may interfere with each other.

For practicality, we assume that the effective transmission range of the PU network 310 is similar to, or larger size than, the SU network 302. Also, we assume that no explicit coordination (e.g., through packet exchange or from an external database) is possible between PUs 312 and SUs 314. This ensures that coexistence approaches can be widely deployed (even with legacy PUs), and be more acceptable to operators.

To keep SUs 314 from accessing the channel when it is accessed by PUs 312, SUs 314 perform spectrum sensing to determine if there are any PUs 312 on the channel. The role of spectrum sensing has been emphasized in the context of DSA coexistence. The effectiveness of DSA coexistence is highly dependent on how correct and timely its knowledge of the underlying spectrum conditions are. To ensure high-fidelity and low-overhead spectrum sensing, spectrum sensing should be performed during a quiet period. The length of such a quiet period depends on the sensing technology used and the confidence-level needed in the sensing result. For high confidence (e.g., >90%) in sensing outcomes, a quiet period may vary from less than 1 ms (for sensing based on energy-detection in high frequency bands) to 100 ms or even more (for sensing based on feature-detection).

Clearly, quiet periods are a significant overhead in DSA, and should be scheduled intelligently to balance application requirements (e.g., bandwidth) with channel-awareness. Unlike the IEEE 802.22 WRAN where the coverage is very wide (33 Km defined in the standard), the coverage of SpeCWiFi is similar to the legacy WiFi systems. Therefore, spectrum sensing will be performed at each SpeCWiFi device 304 in a distributed manner like WiFi systems. In IEEE 802.11 WiFi devices, carrier sensing functionality has already been implemented to avoid collisions with other devices. SpeCWiFi devices 304, when operating on a channel with a PUG 310, should be able to detect PUs 312 on any channel, so carrier sensing should be implemented to function over various spectrum channels and other sensing techniques may be adopted together with the legacy energy detection. We assume that SUs 314 share the same information on quiet periods and presence or absence of a PU 312 is known with reliability in given quiet periods which are scheduled by a medium access control (MAC) module 320.

Some terminology and notation used throughout this disclosure includes:

Incumbent Detection Threshold (IDT): Weakest PU signal strength that must be detectable by SUs.

Channel Detection Time (CDT): Maximum time-interval (from the start of PU transmission) within which SUs must detect PU signals and halt their own transmission.

Coexistence Period (CP): The duration during which a SUG coexists with the PUG on a licensed channel.

There is a tradeoff between PU-safety and SU-efficiency, when PUs access the channel with small ON/OFF durations. A wireless device, when it is transmitting, is unable to detect if any foreign transmission has begun on the channel, which is the fundamental cause of collision in a wireless medium. Hence, an SU transmission can overlap with PU transmissions when SUs are trying to exploit spectrum white spaces. Such interfering overlaps occur at a much higher frequency, when PUs access the channel with smaller ON and OFF durations. In reality, the situation is worse as SUs need more quiet periods for spectrum sensing to reliably detect PUs, but they may not be scheduled after every SU transmission due to the overhead involved. Note that no extra information on the PU transmission schedule is assumed to be available to SUs.

Spectrum White-Space Utilization Problem: Coexistence in licensed channels involves a tradeoff between the following two conflicting objectives: (1). Maximal utilization of channel's white spaces. (2). Zero or minimal interference to the PU transmissions. The best strategy to ensure objective (2) is to remain quiet (i.e., no transmission) on the licensed channel, which clearly conflicts with objective (1).

To mathematically quantify this tradeoff, we first model the PU's (or PUG's) and SU's (or SUG's) active channel usage durations as a set of ordered pairs:

CUI={(tᵢ,tⱼ):channel use from tᵢ to tⱼ,tᵢ<tⱼ}. (1)

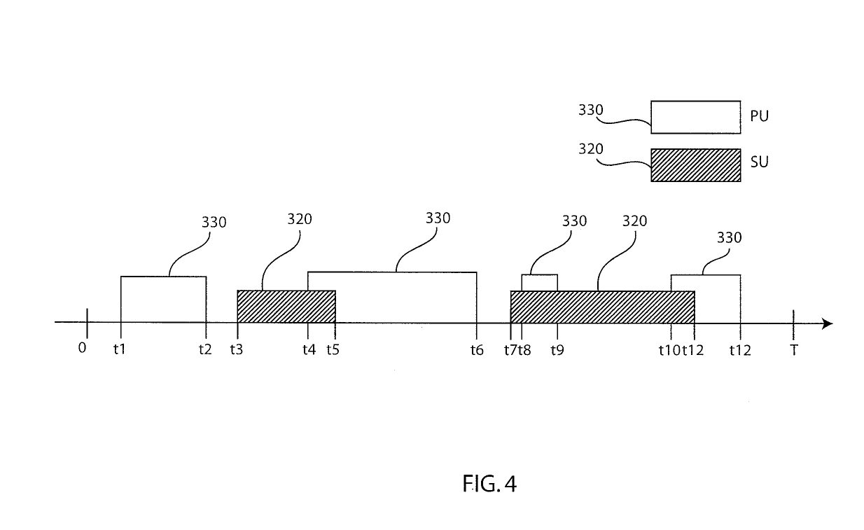

Note that each element of the usage set CUI represents a finite time-interval (channel usage interval (CUI) when the channel was utilized. Also, if (tₐ, t_{b})εCUI and (t_{c}, t_{d})εCUI, then tₐ<t_{c} [symbol] t_{b}<t_{c}, and vice versa. As an example, consider a scenario where SUs coexist with PUs on a licensed channel during interval [0, T], as shown in FIG. 4.

Referring to FIG. 4, a example of PU-SU coexistence on a licensed channel during an internal (0, T) is illustratively depicted. Blocks 320 and 330 represent the duration during which the medium is being accessed by either an SU or a PU, respectively. There can be simultaneous access and hence interference to PUs from SUs as seen in durations (t₄,t₅), (t₈,t₉) and (t₁₀, t_{H}). Then, for FIG. 4, CUI_{PUG}={(t₁,t₂),(t₄, t₆),(t₈, t₉),(t₁₀, t₁₂)}, and, CUI_{SUG}={(t₃, t₅),(t₇,t₁₁)}.

To represent the two goals, we define two factors as follows:

A) Iₚₛ (CUI_{PUG},CUI_{SUG}): PU-SU Interference Factor, or a fraction of PUs' transmission time interfered from SUs' transmissions during the given interval (0≦Iₚₛ≦1).

B) Uₛ (CUI_{PUG},CUI_{SUG}): SUs' Channel Utilization Factor, or a fraction of time utilized by SUs during the given interval (0≦Uₛ≦1).

For example, in FIG. 4, they are given by

$${I}_{ps} = \frac{( {t}_{5} - {t}_{4} ) + ( {t}_{9} - {t}_{8} ) + ( {t}_{11} - {t}_{10} )}{( {t}_{2} - {t}_{1} ) + ( {t}_{6} - {t}_{4} ) + ( {t}_{9} - {t}_{8} ) + ( {t}_{12} - {t}_{10} )} , \\ {U}_{s} = \frac{( {t}_{4} - {t}_{3} ) + ( {t}_{8} - {t}_{7} ) + ( {t}_{10} - {t}_{9} )}{{t}_{1} + ( {t}_{4} - {t}_{2} ) + ( {t}_{8} - {t}_{6} ) + ( {t}_{10} - {t}_{9} ) + ( T - {t}_{12} )} . \qquad ( 2 )$$

Note that the parameters CUI, Iₚₛ, and Uₛ have been defined with a collective network viewpoint (PUGs and SUGs). These can also be used for individual devices (PU and SU), if necessary, to characterize individual nodes' performance. Now, the Coexistence Goodness Factor (CGF) is a two dimensional metric defined as:

CGF(CUI_{PUG},CUI_{SUG})=(Iₚₛ,1−Uₛ) (3).

CGF incorporates both PU-safety and SU-efficiency. This differs from prior work where the optimization function is guided solely by maximizing SUs' channel utilization without attempting to minimize interference to PUs (it is only bounded). Such a strategy was found to be reasonable for slow-varying ON/OFF periods, but this does not work for fast-varying periods. A CGF-based protocol strategy widens the spectrum for applying DSA, and is significantly more acceptable to both PUs and SUs.

The goal in designing SpeCWiFi MAC is to minimize the CGF. For a SUG, the optimization problem can be stated as the following multi-objective optimization problem (MOP). For CUI_{PUG} during the coexistence interval [0, T],

$${min}_{{CUI}_{SUG} = \{ ( {t}_{i} , {t}_{j} ) : 0 \leq {t}_{i} < {t}_{j} \leq T \}} CGF ( {CUI}_{PUG} , {CUI}_{SUG} ) \qquad ( 4 )$$

The solution space of the above MOP includes the possible channel-access schedules for the SUG during the coexistence interval. This MOP can be easily shown to be Pareto-optimal with optimized CGF vector as (0,0). This ideal solution corresponds to the perfect usage of medium by the SUG—100% utilization of the spectrum white spaces on the channel. Theoretically, it is simple to solve the optimization problem in Eq. (4) using the well-known MOP optimization techniques like Aggregate Objective Function (AOF) method or Normal Boundary Intersection (NBI) method. Based on the optimized solution, a SUG can schedule its upcoming transmissions such that the CGF vector during the coexistence interval is absolute minimum.

However, in practice it is difficult to achieve this goal for a number of reasons. First, CUI_{PUG} for any future duration is most likely to be unknown by the SUG. The SUG may try to model PUG behavior and estimate CUI_{PUG}—in which case, the accuracy of the estimate would determine the degree to which the optimization is achieved. Second, the SU-MAC needs to schedule its transmissions in real time which is affected by other channel-related factors (like medium occupied by other SUGs or noise), thus preventing maximal utilization of PU-free intervals. Third, DSA is inherently inefficient as it needs to schedule sensing (and possibly other disruptive events) that can prevent full usage of PU-free durations by the SUG.

We provide low-cost and easily-deployable approaches to minimize the CGF, and also show their applicability in the context of 802.11 networks for implementation of SpeCWiFi.

PU Boundary Region Problem: We define a boundary environment as the scenario where PU signal strength is very low (˜IDT) around a SUG vicinity. Regulation requires detection (and protection) of PUs with signal strength ≧IDT, which is accomplished through spectrum sensing. In a boundary environment, PU-safety requirements may be compromised because conflicting views on PU presence are possible due to spatial spread of SU deployment. Some SUs may be effectively out of range of PUs where PU signal strength is much lower than IDT, while for others, the PU signal strength may be still above IDT. This could lead to the problem of PU-hidden nodes in DSA.

For example, in FIG. 3, node b can transmit to node c without being aware that PU transmission has started affecting node c. Thus, PU receivers within range may experience interference from SUs. These issues need to be addressed for a full DSA coexistence solution. The present approaches include the introduction of PU On (PUO) and PU Ceased (PUC) control packet pairs to accomplish low-overhead alert dissemination when a boundary environment problem is ascertained.

SPECWIFI MAC: To solve the problem of utilizing spectrum white-spaces, SpeCWiFi MAC is provided by enhancing 802.11 DCF for DSA coexistence while maintaining distributed operation semantics.

Adaptive Dual-mode Licensed Operation: For an effective solution to the spectrum white-space utilization problem, SUs co-existence with PUs is ensured in a non-intrusive manner, while at the same time, the available white spaces are maximally exploited. PU-free/busy periods are determined as accurately as possible, so that SUs can utilize the channel when it is free from PUs. To achieve this goal, a dual-mode DSA MAC operation is provided as described with reference to FIG. 2. A safe mode (SM) and aggressive mode (AM) are included for when an SU utilizes a licensed channel. In unlicensed (or home) channels, legacy (non-DSA) MAC operations occur, which are called Normal Mode (NM). There are also other issues, such as when SpeCWiFi should switch between NM and SM and which channel a SUG should choose for licensed channel use.

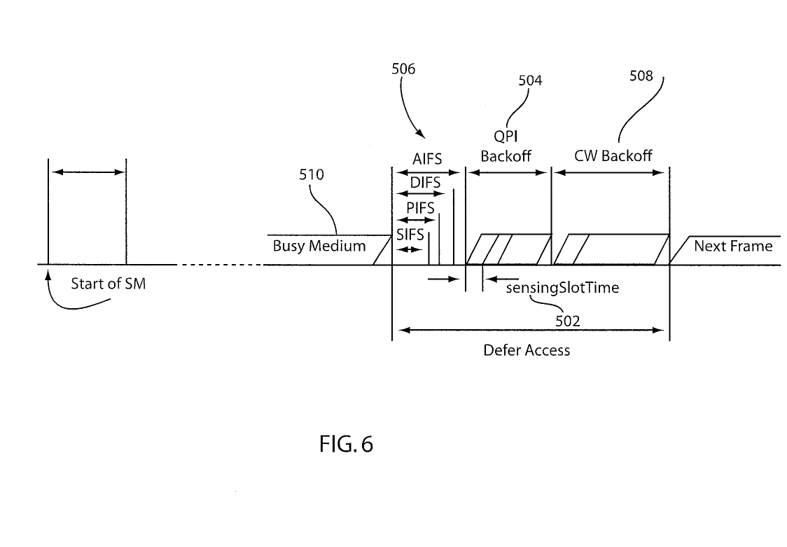

The carrier sensing functionality of 802.11 MAC is extended to spectrum sensing during quiet periods. The primary goal of spectrum sensing is to detect PUs, so the mechanism of inter-frame space (IFS) such as DIFS or PIFS (see FIG. 6) used in 802.11 is not considered. Contention by SUs can be resolved by Contention Window (CW) backoff that is the same as in 802.11. The carrier sensing functionality may be combined with backoff to detect other SUs.

Referring to FIG. 5, a state-transition diagram illustratively shows different modes of DSA MAC operations for DSA coexistence in accordance with the present principles. Operations in unlicensed bands constitute normal mode (NM), while safe mode (SM) and aggressive mode (AM) are used when operating on licensed channels. Block 402 shows a state when a pattern of PU use is detected.

Safe Mode (SM): SM is the default mode of DSA operation of SUs, when operating in licensed channels. Once an SUG enters a licensed channel, it starts operation in SM, and may switch to AM anytime when a regular PU channel-usage pattern is detected. Conversely, the SUG will switch from AM to SM, if the expected PU channel-usage pattern is violated. The basic principle behind SM is to “transmit less, observe more.” This permits SUs to continuously gather sensing data without too many time-gaps. Such a high-quality time-series of sensing information is useful to determine PU channel-usage patterns on the channel, if any exists.

An Atomic Packet Exchange (APE) is defined as a sequence of frame exchanges resulting in a complete transfer of a set of MSDUs (MAC Service Data Units) to the sender. In SM, certain types of APEs such as burst-type exchanges and prioritized access are prohibited to prevent SUs from using the licensed channel for long durations in one stretch. Regular APEs are permitted, with the condition that the APE duration conform to regulatory guidelines.

Every APE is followed by a Quiet Period Interval (QPI), before the channel can be accessed for the next APE. QPI varies with the following strategy (similar to that of contention window in 802.11).

QPI=QPW×sensingSlotTime (5)

QPW is the quiet period window and takes an integer value in the range over the interval [1,QPWₘₐₓ]. The minimum duration adequate for high-fidelity spectrum sensing is indicated by sensingSlotTime (502 in FIG. 6), and its value is a fixed input derived from the sensing technology used.

QPW (or equivalently QPI) is varied based on recent sensing observations to adaptively balance the SU's need for sensing opportunities versus data transmission. The initial value of QPW is QPWₘₐₓ. For every QPI resulting in PU absence, QPW is reduced by a factor of 0.5. Once QPW reaches QPWₘᵢₙ, it remains at this value until it is reset. Thus, even in SM, data transmission can be more frequent when PUs are not observed on the channel for a long time. If a PU is detected during the QPI, QPW is reset to QPWₘₐₓ. QPI is then re-initialized. Recent PU detection makes SUs wait longer before attempting to transmit even when medium may be sensed to be free currently, as the PUG could likely be engaged in an ongoing communication session.

Referring to FIG. 6, a diagram showing channel access is illustratively shown. In wireless systems, after every packet transmission, sufficient turnaround time is needed for decoding and resetting interfaces (e.g., SIFS in 802.11). In SpeCWiFi, QPI (QPI backoff period 504) follows a Turnaround Interval 506 (TI>SIFS) (e.g., SIFS, AIFS, DIFS and PIFS time slots are also illustratively depicted between busy medium 510 and the QPI backoff period 504) after each APE, and proceeds with a CW backoff period 508. Further, though QPI is calculated individually by the SU nodes (using Eq. (5)), they converge to the same value. This is because all the nodes observe similar channel conditions in terms of PU detection. Thus, distributed sensing is achieved without any overhead. We address the case where similar channel conditions may not be observed by all the nodes (e.g., in boundary scenarios) later in this document.

In summary, the safe-cumulative-adaptive strategy followed in SM allows this mode to be conservative, yet utilize the medium as much as possible, yielding improved CGF.

Aggressive Mode (AM): In case there is a pattern of PUs' ON and OFF durations, incurring QPIs before every APE is a significant overhead, thereby deteriorating the SUs' utilization of bandwidth. In reality, 802.16h systems design such a system to transmit frames with periodic ON and OFF durations. Then, SUs may not need to waste QPIs that could be otherwise utilized for their transmissions. Therefore, when a PU-free period is expected, SUs access the channel without frequent QPIs. For this, we define the AM as a second mode of SpeCWiFi MAC.

In contrast to SM, the principle of AM is to “transmit more, observe minimally”. In AM, the channel-usage pattern of PUs is known based on sensing observations gathered in SM. QPIs are scheduled with frequency f_{qpi} to ensure periodic sensing needed to ascertain any out-of-pattern PU traffic. Also, f_{qpi} is conformed to regulatory guidelines in terms of detecting any PU transmission within a short time. Any unexpected detection of PU traffic would result in the PU channel-usage pattern violation, and the SUs switches to SM. QPI duration is calculated in a similar manner as in SM. Since QPI is scheduled relatively infrequently in AM, the QPW value is fixed at QPWₘₐₓ allowing maximum duration for every QPI for more reliable sensing.

Note that if the estimated PU channel-usage pattern is accurate, pattern violation would be infrequent, leading to high utilization of PU-free periods and resulting in a better CGF—which is the goal AM intends to achieve. Clearly, the PU channel-usage pattern needs to be accurately estimated.

Estimating PU Channel-Usage Pattern: The sensing component of DSA provides information on whether PU activity has been detected at different instants on the licensed channel. Using bits 1 (to indicate PU presence) and 0 (to indicate PU absence), the sensing observations can be represented as a binary time-series s, defined as the following: s=[s₁, s₂, . . . , sᵢ₊₁, . . . ], sᵢε{0,1}.

The series s is bounded in number of elements (N) over a finite time-window (W). Each element sᵢ of the series corresponds to the time instant tᵢ, when the corresponding sensing observation was taken. Series s describes the input available for PU channel-usage pattern detection. Many techniques have been used in various fields for pattern recognition and trend analysis, e.g., neural networks and genetic algorithms. However, these techniques are quite complex to implement, and involve very high run-time overhead in terms of computational resources needed and time consumed. Further, such approaches require a high degree of specific training to be effective. Such high overhead techniques may be employed but are not preferable for the MAC design domain, where a MAC module needs to be agile and operates on limited memory and computational power.

Instead, in one embodiment, Approximate Entropy (ApEn) has been selected for pattern recognition based on sensing observations. ApEn is a measure of regularity (or irregularity) present in a discrete sequence, e.g., binary sequences like s. Given a small amount of observations, ApEn can be used to classify complex systems including deterministic and stochastic processes, without any additional information about system behavior. Hence, the ApEn measure is aptly suited for analyzing PU channel-usage behavior. ApEn has been shown to be useful in diverse contexts, e.g., cardiovascular data analysis.

Approximate Entropy (ApEn): Consider the binary series s including N elements or bits. ApEn is defined for each length L of consecutive bit vectors that can be constructed from s. For each vector i of length L, its correlation sum Cᵢ^{L}(r) encapsulates the (normalized) number of vectors (of size L) in s which are “similar” to i within resolution r.

$${C}_{i}^{L} ( r ) = \frac{Num . vectors of length L similar to i}{N - L + 1} .$$

The notion of “similarity” of two vectors is defined based on the maximum corresponding-element difference of the two vectors. For two vectors to be “similar”, the difference needs to be less than resolution factor r. Given the correlation sums for all vectors of size L within resolution r, the mean size L logarithmic correlation sum Φ^{L}(r) of the series s is defined as follows:

$${Φ}^{L} ( r ) = \frac{1}{N - L + 1} {\sum }_{i = 1}^{N - L + 1} log {C}_{i}^{L} ( r ) .$$

Approximate entropy of s is defined as,

$$ApEn ( L , r , N ) ( s ) = \{ \begin{matrix}{Φ}^{L} ( r ) - {Φ}^{L + 1} ( r ) \\ - {Φ}^{L} ( r )\end{matrix} \begin{matrix}, if L \geq 1 , \\ , if L = 0.\end{matrix} \qquad ( 6 ) .$$

ApEn indicates the degree of regularity present in sensing information s. As can be seen from Eq. (6), ApEn≦1. Large values of ApEn (e.g., 0.9) denote irregularity in s, while small values of ApEn (e.g., 0.1) point to the presence of a regular pattern in s. In this context, the ApEn measure can be thought of as predicting the probability of any pattern in s.

For a binary time-series, the possible values for r are either 0 or 1. We use r=0 to ensure the strictest comparison of vectors in s for accurate pattern detection. Other criteria are also contemplated. Method 1 shows pseudo-code for an illustrative computation of an ApEn measure for s. Method 2 shows pseudo-code for an illustrative pattern recognition decision-making computation.

Method 1: ApEn calculations for s

Require: s = [s₁, s₂, . . . , s_{N}], Lₘₐₓ
Require: Maximum expected pattern length Lₘₐₓ
Ensure: Lₘₐₓ + 1 ≦ N

| | |
|---|---|
| 1: | Declare ApEn array ApEn[Lₘₐₓ] {0-indexed} |
| 2: | Declare logarithmic correlation array Φ[Lₘₐₓ] |
| 3: | Φ[0] ← 0 {Initialize boundary condition} |
| 4: | L ← 1 {Initialize pattern length to 1} |
| 5: | while L ≦ Lₘₐₓ + 1 do |

| | |
|---|---|
| 6: | Φ[L] ← 0 |
| 7: | Declare distance array d[N − L + 1][N − L + 1] |
| 8: | for i ← 1 to [N − L + 1] do |

| | |
|---|---|
| 9: | for j ← 1 to i do |

| | |
|---|---|
| 10: | if i = j then |

| | |
|---|---|
| 11: | d[i][j] ← 0 |

| | |
|---|---|
| 12: | else |

| | |
|---|---|
| 13: | d[i][j] ← max_{k←1,2, . . . , L}└\|sᵢ₊ₖ₋₁ − sⱼ₊ₖ₋₁\|┘ |
| 14: | d[i][j] ← d[i][j]]{Using symmetricity of d[i][j]} |

| | |
|---|---|
| 15: | end if |

| | |
|---|---|
| 16: | end for |

| | |
|---|---|
| 17: | end for |
| 18: | Declare correlation vector C[N − L + 1] |
| 19: | for i ← 1 to N − L + 1 do |

| | |
|---|---|
| 20: | C[i] ← 0 |
| 21: | for j ← 1 to N − L + 1 do |

| | |
|---|---|
| 22: | if i ≠ j && d[i][j] ≦ 0 then |

| | |
|---|---|
| 23: | $C [ i ] ← C [ i ] + \frac{1}{N - L + 1} \{ Calculate {C}_{i}^{L} ( 0 ) \}$ |

| | |
|---|---|
| 24: | end if |

| | |
|---|---|
| 25: | end for |
| 26: | $Φ [ L ] ← Φ [ L ] + \frac{C [ i ]}{N - L + 1} \{ Calculate {Φ}^{L} ( 0 ) \}$ |

| | |
|---|---|
| 27: | end for |
| 28: | ApEn[L − 1] ← Φ[L − 1] − Φ[L] {Calculate ApEn(L − 1,0,N)} |
| 29: | L ← L + 1 |

| | |
|---|---|
| 30: | end while |

Method 2: Pattern recognition decision-making:

Require: ApEn[Lₘₐₓ], ApEnₜₕᵣₑₛₕ
1: ApEnₘᵢₙ ← ∞ {Initialization and boundary cases}
2: Lₚₐₜₜₑᵣₙ ← −1
3: Found ← FALSE
4: for i ← 1 to Lₘₐₓ do
5: if ApEn[i] ≦ ApEnₜₕᵣₑₛₕ & ApEn[i] ≦ ApEnₘᵢₙ then
6: ApEnₘᵢₙ ← ApEn[i]
7: Lₚₐₜₜₑᵣₙ ← i
8: Found ← TRUE
9: end if
10: end for
11: return Found,Lₚₐₜₜₑᵣₙ

ApEn measure is employed to detect any pattern in PU channel-usage time-series s available in recent time-window of size W. Pattern recognition is based on the notion of parameterized decision-making. If any of the ApEn values (for s) is less than ApEnₜₕᵣₑₛₕ existence of a pattern is predicted. We present two methods. Method 1 depicts how to calculate ApEn values for time-series s, while Method 2 uses the calculated ApEn values (input from Method 1) to detect the existence of PU channel-usage pattern, if any.

Method 1 encodes the stepwise calculation of ApEn values of the sensing time-series s in an efficient manner. The output of Method 1 is an array of ApEn values (ApEn[Lₘₐₓ]). Method 2 takes array ApEn[Lₘₐₓ] as well as ApEnₜₕᵣₑₛₕ as the key input parameters and decides whether a pattern is present in s based on comparisons with ApEnₜₕᵣₑₛₕ. A pattern of length L is present in series s, if ApEn(L,0,N)≦ApEnₜₕᵣₑₛₕ. The length of the best recognized pattern, if present, is the output of Method 2.

Given the PU-channel usage pattern of length Lₚₐₜₜₑᵣₙ (from Method 2), the SUs estimate the start-time and duration of each PU-free and PU-busy periods (relative to the current time) in the following manner.

Let tᵢ be the time instant when sensing observation sᵢ was observed. A key insight is that the most recent sensing observations Sₚₐₜₜₑᵣₙ={s₁, s₂, . . . , s_{L}_{ₚₐₜₜₑᵣₙ}} will repeat over the next Tₚₐₜₜₑᵣₙ time-interval. Thus, the PU-free/busy periods are estimated based on the elements of the Sₚₐₜₜₑᵣₙ and the difference between their observation time. For example, if the values of successive pattern elements {sᵢ,sᵢ₊₁} are {0,0}, then PU-free duration of {tᵢ−tᵢ₊₁} is predicted. The case for {1,1} is similar where PU-busy period is predicted. For observations of type {0,1} or {1,0}, the transition is assumed to be midway between the individual observation times. The exact transition times may not be known and depend on the granularity of sensing frequency and duration. Any conflicts during an initial phase of such transitions are ignored.

As an estimated pattern may not be 100% accurate, there needs to a reasonable margin for error tolerance. Any mismatch in prediction and expectation of PU-free/busy period results in probabilistic switch to SM based on ApEnₜₕᵣₑₛₕ value. If the fraction of mismatches observed becomes greater than ApEnₜₕᵣₑₛₕ, the SUs switch back to conservative SM to re-estimate the PU channel-usage pattern.

BOUNDARY ENVIRONMENT: Low-power/hidden PU issues related to unlicensed coexistence in boundary environments is addressed. In such scenarios, there needs to be mechanisms for information propagation between SUs to resolve conflicting views among SUs on PU presence. For example, in FIG. 3, SUG 1 node c should be able to inform node b of existence of PU on the channel.

On-demand control packets (similar to RTS/CTS) can be used to achieve this goal. This approach is placed in the context of SpeCWiFi. SpeCWiFi introduces a new control packet pair, PUO-PUC. The PU On (PUO) packet indicates the presence of PUs, while PU Ceased (PUC) indicates the end of PU transmission on the channel. PUO and PUC form a node-specific control packet pair—a PUO packet from an SU node is followed by a PUC packet from the same node to complete the exchange sequence. The PUO packet is broadcast by an SU node when it detects (or expects) any SU transmission (from other SUs) while it has knowledge of simultaneously ongoing PU activity on the channel.

After the PUO packet is broadcast, the sender broadcasts a PUC packet when it subsequently finds the medium to be free from PU signal. Both PUO and PUC packets include a sender's identifier field. Any node receiving a PUO packet halts its own transmission and updates its sensing information. On receiving a subsequent PUC packet, the node again updates the sensing information and can resume its normal transmission activity. This approach exploits the observation that it is very likely for SU control packets to be received without significant errors even in the presence of a PU signal. This is because in boundary environments the PU signal is quite low (or absent for some SUs) and SU signal strength is comparatively much higher. Further, randomized delay can be used to prevent multiple SUs from broadcasting PUOs at the same time.

In accordance with an illustrative implementation, the viability and performance of SpeCWiFi were demonstrated by implementing the present principles in Atheros-based WLAN chipsets and making use of the open-source Madwifi device driver (madwifi-0.9.4). Preferably, many of the SpeCWiFi features should have a hardware systems-on-chip implementation for precise, real-time, low-level MAC operation, similar to the current network interface cards available in the market. The entire SpeCWiFi access model (including sensing emulation) and state machine were implemented within interface driver software. The SpeCWiFi implementation includes the entire state machine (FIG. 4) together with its access model (FIG. 5).

The PU traffic was emulated using click-1.6.9 modular router within the Linux kernel together with the Madwifi driven wireless interface. The click module can be configured to generate the desired periodic burst of packet streams (every 150 μs) to emulate PU ON period, while there is no transmission during OFF periods. To reduce variation in ON/OFF times, various Madwifi driver settings are controlled (e.g., cw min=cw max=0).

A challenge in emulating PU using 802.11 based cards, is to prevent CSMA and backoff during PU ON time. This is accomplished by setting appropriate Madwifi configuration parameters (like TXOP backoff is disabled), and by constructing the testbed such that PU transmitter is out of range of SU transmissions.

A testbed setup was designed according to the system model (see FIG. 3) with one SU network and one PU network, both consisting of a transmitter-receiver pairs. The machines employed were Dell® Inspiron® 600m laptops with 512 MB-1 GB RAM and 1.8-2 GHz Pentium M processor, and running Ubuntu 8.04 Linux with 2.6.24-23 pre-emptable kernel. Linksys wireless A+G cards (model WPC55AG) were employed. The networks had different ESSIDs and the transmitters operate in Master mode, while the receivers are in Sta mode. To ensure that PU does not back off and has a larger range, the PU transmitter operates at high power (18 dBm), and is situated far away (≈25 ft) from SU nodes. SU nodes operate at 5 dBm, and the PU receiver is kept within the range (≈5 ft) of SU transmissions to analyze the interference caused. Also, we used 802.11a channel 36 (5.18 GHz) for our experiments as it was found to be free of other interfering devices in our laboratory setting.

Netperf with UDP was used to analyze the end-to-end performance on SUs. The default sensing granularity used was 1 ms and the default PU pattern is kept as 5 ms/5 ms (ON/OFF). Other default values for parameters were: N=100, Lₘₐₓ=50, ApEnₜₕᵣₑₛₕ=0.1.

Performance Metrics: CGF (in terms of Iₚₛ and Uₛ) is the metric of evaluation of the coexistence schemes through SpeCWiFi in accordance with the present principles. Since the information about exact time instants of medium free/busy is inaccessible from hardware, we make use of the direct correlation between throughput (or data-rate) achieved and channel utilization. To compute Uₛ, we divide the throughput achieved with the maximum throughput seen when vanilla 802.11 operates on the same channel with no interfering transmissions. To compute Iₚₛ, we compute the ratio of packets/second achieved at the PU receiver with the rate at which PU transmitter sent out the packets. The results show that SpeCWiFi achieves efficient and safe PU-SU coexistence in a channel characterized by fast-varying PUs. Timing analysis shows that about 85% of the time is spent in AM. Also, with 50% channel usage by PU, TCP stream utilization is around 0.32 (≈9 Mbps), with interference to PUs less than 2%. Clearly, general consumer applications like VoIP can also be supported during unlicensed access with SpeCWiFi.

The present embodiments, provide safe, and efficient time-domain coexistence of SUs on an unlicensed basis along with PUs in a licensed channel. Coexistence Goodness Factor (CGF) has been employed as a coexistence performance metric. The coexistence solution includes low overhead methods for Approximate Entropy (ApEn) based on PU pattern recognition and the corresponding transmission scheduling. A dual-mode MAC operation strategy was introduced to enable incorporation in real systems. An implementation based on 802.11 called Spectrum-Conscious WiFi (SpeCWiFi) was built and tested. The evaluation has shown that SpeCWiFi performs well (SU utilization 96+% with interference to PUs less than 2%, for 50% PU usage), indicating the feasibility of applying DSA based coexistence in a more universal manner, including in relatively untouched spectrum bands. Hence, PU/SU coexistence in the licensed spectrum is shown to be able to contribute significantly in improving future wireless systems (beyond 4 G) performance while simplifying protocol design.

Having described preferred embodiments of a system and method for utilizing spectrum operation modes in dynamic spectrum access systems (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for enabling primary and secondary user coexistence for a wireless system, comprising:
performing spectrum sensing in a channel to determine primary user usage in a first mode of operation;
detecting whether the primary user usage includes a pattern of usage; and
if a pattern of usage is detected, adjusting to a second mode of operation which includes at least reducing spectrum sensing by a secondary user and permitting secondary user usage of the channel.

2. The method as recited in claim 1, wherein detecting whether the primary user usage includes a pattern of usage comprises applying a pattern recognition method to determine the pattern of usage.

3. The method as recited in claim 1, wherein detecting whether the primary user usage includes a pattern of usage comprises computing a correlation sum to determine a similarity between vectors to compute an approximate entropy measure to determine whether the pattern exists.

4. The method as recited in claim 1, wherein reducing spectrum sensing by a secondary user to permit secondary user usage of the channel includes measuring a coexistence goodness factor (CGF) to determine efficient usage of the channel.

5. The method as recited in claim 1, wherein the coexistence goodness factor (CGF) balances utilization of channel white spaces and interference with primary user usage of the channel.

6. The method as recited in claim 1, wherein spectrum sensing is performed by a secondary user.

7. The method as recited in claim 1, wherein if the pattern of usage is violated, readjusting to the first mode of operation.

8. A computer readable storage medium comprising a computer readable program for enabling primary and secondary user coexistence for a wireless system, wherein the computer readable program when executed on a computer causes the computer to perform the steps of:
performing spectrum sensing in a channel to determine primary user usage in a first mode of operation;
detecting whether the primary user usage includes a pattern of usage; and
if a pattern of usage is detected, adjusting to a second mode of operation which includes at least reducing spectrum sensing by a secondary user and permitting secondary user usage of the channel.

9. The computer readable storage medium as recited in claim 8, wherein detecting whether the primary user usage includes a pattern of usage comprises applying a pattern recognition method to determine the pattern of usage.

10. The computer readable storage medium as recited in claim 8, wherein detecting whether the primary user usage includes a pattern of usage comprises computing a correlation sum to determine a similarity between vectors to compute an approximate entropy measure to determine whether the pattern exists.

11. The computer readable storage medium as recited in claim 8, wherein reducing spectrum sensing by a secondary user to permit secondary user usage of the channel includes measuring a coexistence goodness factor (CGF) to determine efficient usage of the channel.

12. The computer readable storage medium as recited in claim 8, wherein the coexistence goodness factor (CGF) balances utilization of channel white spaces and interference with primary user usage of the channel.

13. The computer readable storage medium as recited in claim 8, wherein spectrum sensing is performed by a secondary user.

14. The computer readable storage medium as recited in claim 8, wherein if the pattern of usage is violated, readjusting to the first mode of operation.

15. A system for enabling primary and secondary user coexistence for a wireless system, comprising:
a primary user group comprising at least one primary user authorized to use a wireless channel;
a secondary user group comprising at least one secondary user authorized to use the wireless channel in non-use periods of the at least one primary user;
a secondary user device configured to perform spectrum sensing on the wireless channel to determine primary user usage in a first mode of operation and to detect whether the primary user usage includes a pattern of usage; and
the secondary user device including a transceiver configured to switch to a second mode of operation if a pattern of usage is detected such that spectrum sensing is at least reduced such that secondary user usage of the channel is permitted.

16. The system as recited in claim 15, wherein the secondary user device includes a pattern recognition method stored in storage media to determine the pattern of usage.

17. The system as recited in claim 15, wherein the pattern recognition method computes an approximate entropy measure to determine whether the pattern exists.

18. The system as recited in claim 15, wherein reducing spectrum sensing by a secondary user to permit secondary user usage of the channel includes measuring a coexistence goodness factor (CGF) to determine efficient usage of the channel.

19. The system as recited in claim 15, wherein the secondary user device computes a coexistence goodness factor (CGF) which balances utilization of channel white spaces and interference with primary user usage of the channel.

20. The system as recited in claim 15, wherein the secondary user device snitches to the first mode of operation if the pattern of usage is violated.
